(19) United States
(12) Patent Application Publication
(10) Pub. No.: US 2004/0205498 A1
(43) Pub. Date: Oct. 14, 2004

(54) Displaying electronic content

(76) Inventor: John David Miller, Portland, OR (US)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 09/995,951

(22) Filed: Nov. 27, 2001

(51) Int. Cl. G09G 5/00; G06F 17/24

(52) U.S. Cl. 715/501.1; 345/700

(57) ABSTRACT

Creating a three-dimensional collage includes receiving control parameters, creating content objects in accordance with at least one of the control parameters, creating three-dimensional graphics objects in accordance with at least one of the control parameters, arranging the three-dimensional graphics objects in accordance with at least one of the control parameters, and positioning the content objects on the three-dimensional graphics objects.

### TECHNICAL FIELD

This invention relates to displaying dimensionalized electronic content in three dimensions (3D) on a graphics rendering device, such as computer screen, hand-held computing device, or television.

### BACKGROUND

Existing systems provide a user with methods for displaying and manipulating dimensionalized electronic content. One such system uses time as the primary attribute for arranging the content and for providing a two-dimensional (2D) timeline representation. In this system, each piece of electronic content is placed in its absolute position along a timeline. Another existing system provides an electronic program guide (EPG) that arranges a listing of scheduled television programs in a two-dimensional grid. Each column of the grid represents a time slot and each row of the grid represents a broadcast or cable program channel.

### DESCRIPTION OF THE DRAWINGS

FIG. 1 is a block diagram of an interactive electronic content distribution network.

FIG. 2 is a flowchart showing a process for creating a collage of objects representing temporal electronic content.

FIG. 3a is a top view of a reverse chronological straight-on layout arrangement of electronic content.

FIG. 3b is a perspective view of the reverse chronological straight-on layout arrangement of the electronic content shown in FIG. 3a.

FIG. 4a is a top view of a chronological staggered layout arrangement of electronic content.

FIG. 4b is a perspective view of the chronological staggered layout arrangement of the electronic content shown in FIG. 4a.

FIGS. 5a to 5d show representations of a collage created using the process of FIG. 2.

FIGS. 6 and 7 show actual graphical representations of collages created using the process of FIG. 2.

### DESCRIPTION

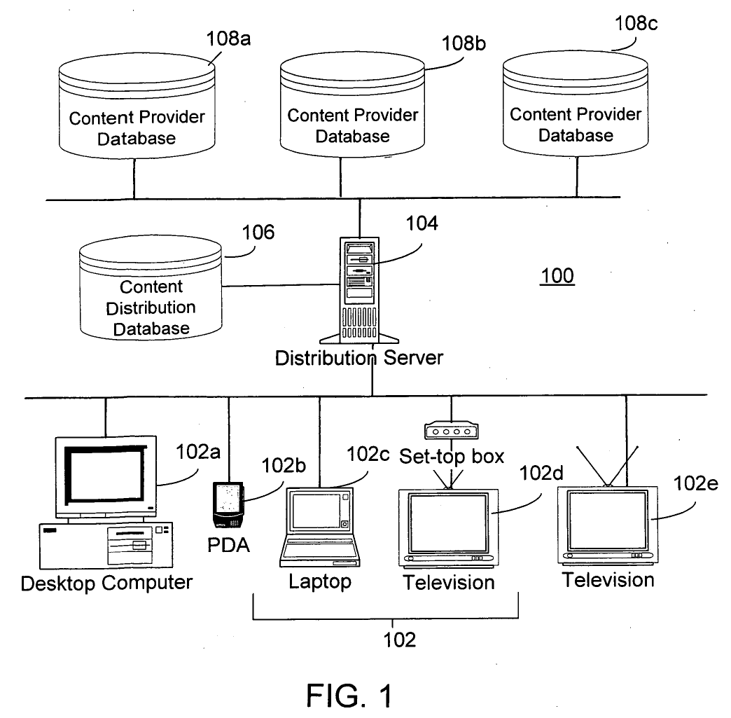

FIG. 1 shows an example of an interactive electronic content distribution network 100. Network 100 includes multiple graphical user interface (GUI) units 102, each configured to display a 3D arrangement of objects representing electronic content. The GUI units 102 may take the form of, e.g., a desktop computer 102a, personal digital assistant (PDA) 102b, laptop computer 102c, set-top box coupled to a television set 102d, or television set 102e with an incorporated user interface unit. However, the embodiments described herein use the desktop computer only.

A distribution server 104 connected to network 100 maintains a content distribution database 106 suitable for use with electronic content provided by one or more content provider databases 108a to 108c. In another embodiment, the content database (or databases, as the case may be) resides directly on a device 102a to 102e.

Each entry in content distribution database 106 may include a content identifier and content information. The content identifier identifies each element of electronic content uniquely. The identifier enables distribution server 104 to locate (e.g., in a content provider database 108a to 108c) and obtain a copy of the electronic content that corresponds to the identifier.

The content information specified in a database entry defines a time value, content type, content category, and content provider associated with each element of electronic content. For example, each database entry may have the following format: <identifier=“content identifier”; time=“time value”; type=“content type”; category=“content category”; source=“content provider”>. The data is referred to as “multi-dimensional” because it has different aspects, e.g., time, type, category, source, etc.

The time value can be represented in any form, for example, by decade, year, month, day, hour, or some combination thereof. The content type may include any type of media in which electronic content can be represented. Suitable content types include, but are not limited to, an image, sound byte, movie clip, and text. The content provider can be a publisher, distributor or Web retailer of online content, such as Billboard.com; a music label, such as Columbia Records; a studio and production company, such as Miramax Films; a television studio, such as Warner Brothers; a newspaper publisher, such as The Washington Post Company; or alternatively, a user who stores digital photos on a personal computer. The content provider or an end-user may embed, in the electronic content, a category (e.g., birthday, anniversary, New Year's) to which the electronic content should be classified. For example, a digital photo stored on an end-user's personal computer can be cataloged in the content distribution database 106 as: <identifier=“Joe's 5th Birthday”; time=“06202001”; type=“image”; category=“birthday”; source=“Bob's personal photo album”>.

Described herein are a method and apparatus for organizing, arranging, displaying, and interacting with the multi-dimensional data. One dimension of the data is chosen as the primary dimension. The data is divided into some number of “slices” along the primary dimension and displayed within the graphical space allotted for that slice.

By way of example, time may be selected as the primary dimension. In this example, each slice may be graphically represented as a translucent sheet upon which a collage of items representing temporal data is displayed. The result may be a static image, movie image, animation, text, audio clip, and/or combination thereof. These items may dynamically fade in and out and then reappear elsewhere on a slice to give a collage a dynamic, animated appearance.

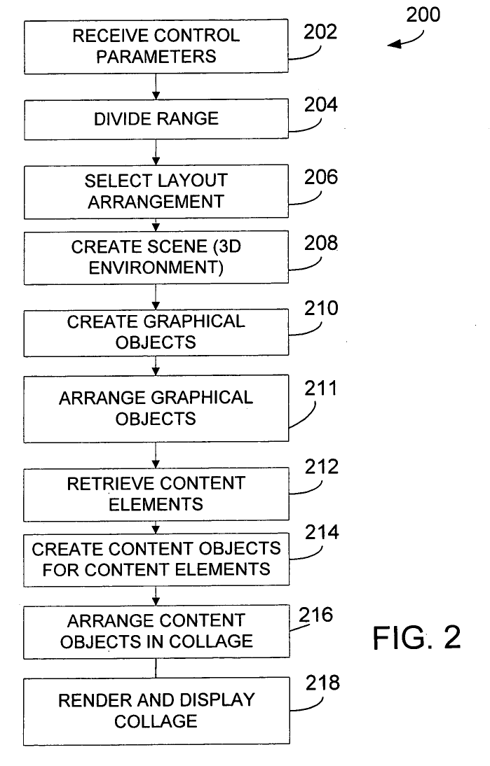

FIG. 2 shows a process 200, which may be implemented by a computer program residing on an end-user's computer 102a. In process 200, electronic content for a particular time range may be dynamically arranged together in a collage representing that time slice. A number of these slices may be arranged sequentially within a 3D computer graphics scene (i.e., environment), such that the user may navigate back and forth through the content's temporal range by navigating through these time slices in the 3D computer graphics scene.

In the example described here, time is considered as the primary dimension. Other embodiments may use other data attributes as the primary dimension. For example, the alphabet may be used as the primary dimension, with each slice representing a range in an alphabetized list of content items.

Note also, that in the current example, the content items are records describing television programming content. However, any dataset of records from any database may be used instead of, or in addition, to television programming content. For example, the content of a real estate database may be displayed, with a street address, price range, or square footage as the primary dimension.

Parameters

Process 200 receives (202) control parameters. These parameters may be pre-stored and provided to the user. Alternatively, process 200 may prompt the user for these parameters or they may be determined programmatically or provided by distribution server 104.

A control parameter may specify an initial time range, such as 1967 to 1976. Other control parameters may specify the units by which to divide the time range into time slices. For example, the time range may be divided (204) into time slices representing a decade, year, month, day, or hour. Process 200 may be configured to divide the time range automatically, as follows:

(1) For a time range spanning less than a day, divide the time range into time slices, each time slice representing an hour.

(2) For a time range spanning less than a month, divide the time range into time slices, each time slice representing a day.

(3) For a time range spanning less than a year, divide the time range into time slices, each time slice representing a month.

(4) For a time range spanning less than a decade, divide the time range into time slices, each time slice representing a year.

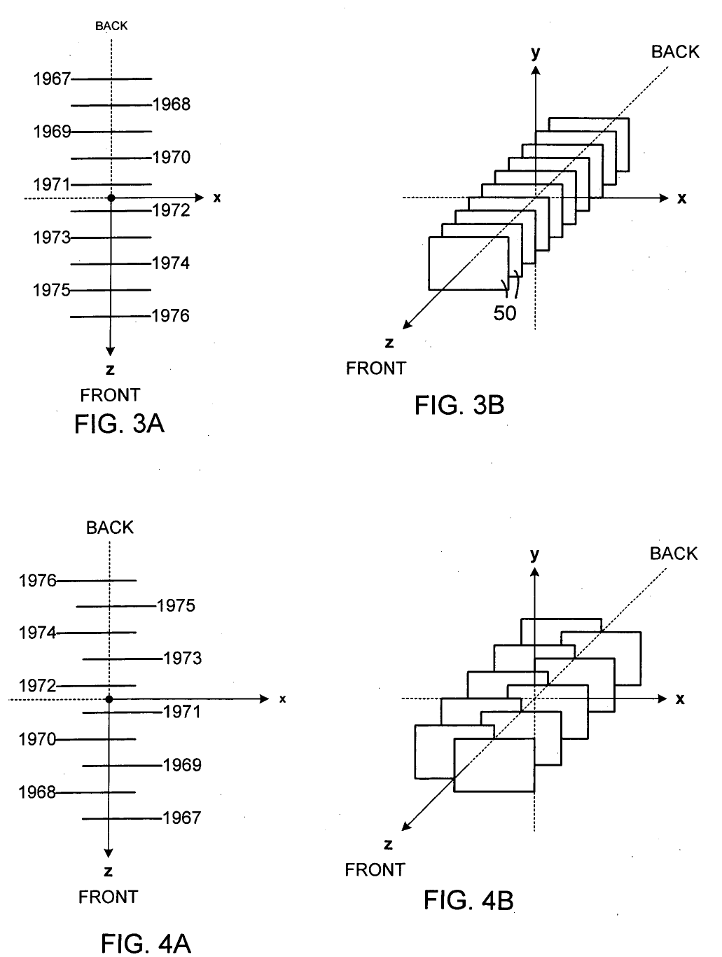

Another control parameter (the “layout parameter”) is used to select (206) a layout arrangement for arranging the time slices and a navigational model for navigating between the time slices in the 3D graphics scene. This parameter determines whether to organize the time slices linearly with the user facing them head-on (see FIGS. 3a and 3b), staggered (see FIGS. 4a and 4b), or sideways (not shown).

Other parameters identify electronic content from the content database to produce a dataset. In the EPG example, the control parameters may be used to select content by genre, actor, channel, program length, and whether the program is a repeat broadcast. Information from other devices, such as a set-top box, may be used to permit selection or filtering based on whether the user has seen the program before.

Operation

Process 200 creates (208) a scene within a 3D coordinate space using an arbitrary origin (0,0,0) and three coordinate axes (x,y,z). By convention, these axes are perpendicularly arranged in either a “left-handed” configuration, where +x points to the right along a horizontal ground plane, +y points straight upward, and +z points toward the user, along the ground plane. An alternate “right-handed” configuration is identical except for the direction of +z, which points away from the user, opposite that of the left-handed configuration. Descriptions here will assume a left-handed coordinate system. The 3D coordinate space of the scene is referred to as the “global coordinate space”.

A typical 3D computer graphics scene also provides information about lights and a virtual camera. Generally, the scene defines the number of lights in the scene, their locations in the global coordinate space, their orientations (if they are directional lights), and all the other information that a 3D computer graphics rendering engine would require to produce the scene.

A virtual camera (not shown) is also assigned a location in the global coordinate space, an orientation, and a field of vision. The location of the camera in the global coordinate space represents the spot from which an “eye” looks at the scene. Like a human eye, the camera has an orientation that defines the direction in which it looks, as well as a field of vision that defines an angle projecting out from this viewpoint. Objects that fall within the angle can be seen by the camera (and therefore, the end-user), and those falling outside of it cannot.

Process 200 creates (210) graphical objects, one for each time slice in the time range. A graphical object (called a “unit form”) may constitute a translucent, gridded sheet with a text field label that specifies the time slice represented by that unit form. As is the case for all graphical objects in a typical 3D computer graphics scene, each unit form is defined by its own local coordinate space, with an origin (0,0,0) at the center of that object.

Process 200 arranges (211) the set of unit forms (e.g., 50 in FIG. 3b) within the global coordinate space of the scene based on the layout arrangement parameter described above. Assume, for example, that the end-user elected to divide the 10-year time range of 1967 to 1976 into 10 time slices, and to arrange the time slices using a reverse chronological straight-on layout arrangement. In this case, the unit forms are arranged as shown in FIGS. 3a and 3b, which are top and perspective views, respectively. When placed in reverse chronological order, the time slices are arranged such that the unit form of the “1976” time slice has the highest z value, and the unit form of the “1967” time slice has the lowest z value.

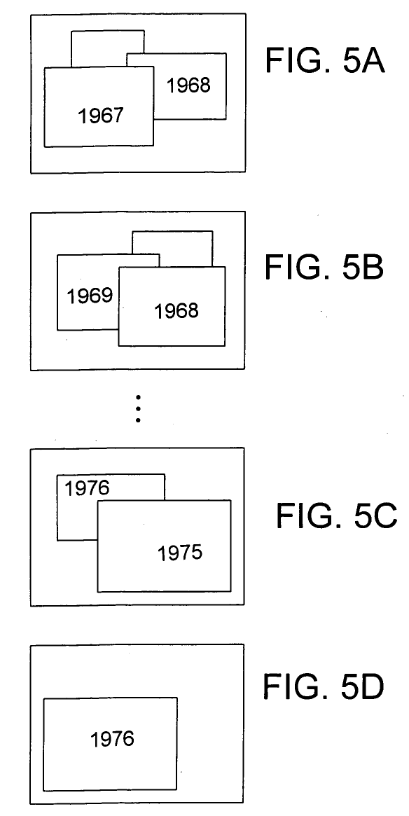

Other layout arrangements include, but are not limited to, a side-by-side arrangement (not shown) and a chronological staggered layout arrangement shown in FIGS. 4a and 4b. When placed in forward chronological order, the time slices are arranged from earliest-to-latest, front-to-back, such that the unit form of the “1967” time slice has the highest z value (is in front), and the unit form of the “1976” time slice has the lowest z value. FIGS. 5a to 5d show a front view of a staggered layout arrangement with time slices removed starting with 1967 in FIG. 5a, leaving 1976 in FIG. 5d. Other arrangements may also be used.

Process 200 queries content distribution database 106 to retrieve (212) records (i.e., content elements) that correspond to the content parameters. For each such record, process 200 creates (214) a 3D computer graphics object (called “content particle”) that represents the electronic content in the scene. In one embodiment, each content particle created by process 200 has geometry and surface attributes, such as color and transparency, and is defined by its own local (e.g., XY) coordinate space.

The actual graphical design of these content particles is subject to artistic interpretation. The content particles may be constructed as descriptive shapes or icons, as static or moving images, or as text. Color-coding may also be used to indicate various content attributes, such as genre.

Content particles may also include an audible component in addition to, or instead of, a graphical component. In one embodiment, such particles play audio clips when the virtual camera comes near them, when the user gestures (e.g., double-clicks) for their playback, or by some other programmatic means. For example, these particles may play hit songs and poignant audio clips (e.g., “That's one small step for a man . . . one giant leap for mankind.”) from the year (1969) of that time slice as the user browses through the scene.

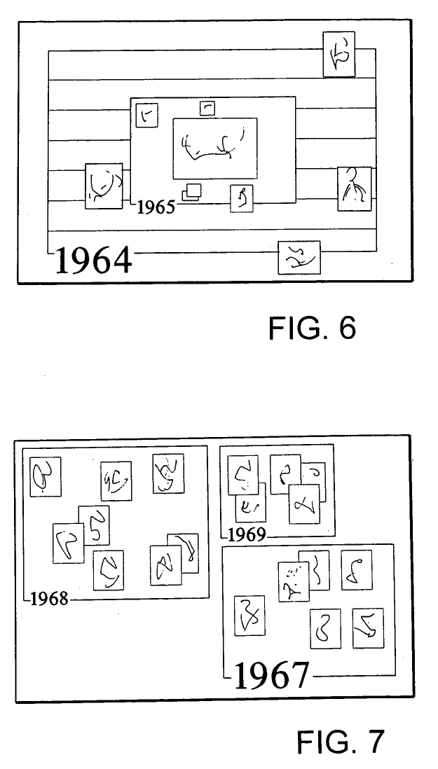

Process 200 represents each data record by a “content particle” that may be a still or moving picture, graphical icon, audio clip, or other design. Process 200 arranges (216) the appropriate content particles within each unit form in a collage and displays (218) the collage on a GUI. FIGS. 6 and 7 show examples of collages displayed by process 200.

The collages may be dynamically animated such that content particles fade in and out. Particles may be animated across the unit form. Particles that fade in and out may reappear at the previous location or at another location on the unit form. A subset of particles may be displayed on the unit form at any one time, optionally cycling through the full set in either a determined or random manner.

Other arrangements of content particles are possible, including, but not limited to, a 2D array, matrix, clustering, grouping, or a combination of techniques.

The order of events described herein is not specific to the invention; embodiments may choose to perform these actions in a different order or only in part. For example, one embodiment may elect to generate unit forms and particles only for a certain range of slices so as not to create graphical objects that are outside the current view, thus reducing the resource demands of a computer or reducing the time required to generate the display. Other embodiments may elect to create these objects, but not to display them unless they are within the current view.

Computer animation is performed by a repeated succession of moving and then drawing or “rendering” visible objects. The mechanics of 3D graphics are well known to one skilled in the art, as defined, e.g., by such industry standard “application programming interfaces” as OpenGL or Open Inventor™. Process 200 may be implemented using a computer program written in accordance with these standards.

Process 200 can be used to create a user-navigable, 3D electronic program guide of television show times. For example, content distribution database 106 may be used to catalog information related to television shows provided by one or more television networks. A user can interact with electronic content distribution network 100 using a television 102e to create a collage of objects representing television shows occurring, e.g., on Wednesday, Aug. 6, 2001, between 10am and 3pm. Process 200 can also allow the user to download images or details about a television program, scheduled to be broadcast during that time, from a remote server.

Process 200 is not limited to use with the hardware and software of FIG. 1. It may find applicability in any computing or processing environment. Process 200 may be implemented in hardware, software, or a combination of the two. Process 200 may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform process 200 and to generate output information.

Each such program may be implemented in a high level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette), that is readable by a general or special purpose programmable computer for configuring and operating the computer when the storage medium or device is read by the computer to perform process 200. Process 200 may be implemented as a machine-readable storage medium, configured with a computer program, where, upon execution, instructions in the computer program cause a machine to operate in accordance with process 200.

It is noted that, in response to a user selection, the machine running process 200 makes a corresponding data selection. So, any selection operation can be conceived of as both a user and a machine selection. It is also noted that the term “three-dimensional”, as used herein, refers to the virtual 3D space in the context of a computer graphics environment, and not to real-life 3D.

The invention is not limited to the embodiments described herein. For example, the blocks of FIG. 2 can be performed in a different order and still achieve desirable results.

Other embodiments not specifically described herein are also within the scope of the following claims.

What is claimed is:

1. A method comprising:
receiving a control parameter that identifies electronic content in a database;
creating content objects that correspond to the electronic content; and
arranging the content objects as a three-dimensional collage.

2. The method of claim 1, further comprising:
receiving control parameters that identify a range and divisions to the range;
creating three-dimensional graphics objects that correspond to divisions of the range; and
arranging the three-dimensional graphics objects as the collage;
wherein arranging the content objects as the three-dimensional collage comprises positioning the content objects on the three-dimensional graphics objects.

3. The method of claim 2, wherein the range comprises a time range and the divisions of the range comprise time slices.

4. The method of claim 2, wherein the three-dimensional graphics objects are arranged according to a straight-on layout arrangement, a staggered layout arrangement, and a side-by-side layout arrangement.

5. The method of claim 2, further comprising:
receiving a layout arrangement control parameter;
wherein the three-dimensional graphics objects are arranged in accordance with the layout arrangement control parameter.

6. The method of claim 2, wherein at least one of the three-dimensional graphics objects includes an audio component.

7. The method of claim 1, further comprising:
creating a three-dimensional graphics environment for the three-dimensional collage.

8. The method of claim 1, wherein the three-dimensional collage comprises an electronic program guide that identifies shows that are broadcast at specified times.

9. A method of creating a three-dimensional collage, comprising:
receiving control parameters;
creating content objects in accordance with at least one of the control parameters;
creating three-dimensional graphics objects in accordance with at least one of the control parameters;
arranging the three-dimensional graphics objects in accordance with at least one of the control parameters; and
positioning the content objects on the three-dimensional graphics objects.

10. The method of claim 9, wherein the control parameters comprise parameters that identify electronic content for the content objects, identify a range and divisions to the range for the three-dimensional graphics objects, and a layout arrangement for the three-dimensional graphics objects.

11. An article comprising a machine-readable medium that stores executable instructions to:
receive a control parameter that identifies electronic content in a database;
create content objects that correspond to the electronic content; and
arrange the content objects as a three-dimensional collage.

12. The article of claim 11, further comprising instructions that cause the machine to:
receive control parameters that identify a range and divisions to the range;
create three-dimensional graphics objects that correspond to divisions of the range; and
arrange the three-dimensional graphics objects as the collage;
wherein arranging the content objects as the three-dimensional collage comprises positioning the content objects on the three-dimensional graphics objects.

13. The article of claim 12, wherein the range comprises a time range and the divisions of the range comprise time slices.

14. The article of claim 12, wherein the three-dimensional graphics objects are arranged according to a straight-on layout arrangement, a staggered layout arrangement, and a side-by-side layout arrangement.

15. The article of claim 12, further comprising instructions that cause the machine to:
receive a layout arrangement control parameter;
wherein the three-dimensional graphics objects are arranged in accordance with the layout arrangement control parameter.

16. The article of claim 12, wherein at least one of the three-dimensional graphics objects includes an audio component.

17. The article of claim 11, further comprising instructions that cause the machine to:
create a three-dimensional graphics environment for the three-dimensional collage.

18. The article of claim 11, wherein the three-dimensional collage comprises an electronic program guide that identifies shows that are broadcast at specified times.

19. An article comprising a machine-readable medium that stores executable instructions to create a three-dimensional collage, the instructions causing a machine to:
receive control parameters;
create content objects in accordance with at least one of the control parameters;
create three-dimensional graphics objects in accordance with at least one of the control parameters;
arrange the three-dimensional graphics objects in accordance with at least one of the control parameters; and
position the content objects on the three-dimensional graphics objects.

20. The article of claim 19, wherein the control parameters comprise parameters that identify electronic content for the content objects, identify a range and divisions to the range for the three-dimensional graphics objects, and a layout arrangement for the three-dimensional graphics objects.

21. An apparatus comprising:
a memory that stores executable instructions; and
a processor that executes the instructions to:
receive a control parameter that identifies electronic content in a database;
create content objects that correspond to the electronic content; and
arrange the content objects as a three-dimensional collage.

22. The apparatus of claim 21, wherein the processor executes instructions to:
receive control parameters that identify a range and divisions to the range;
create three-dimensional graphics objects that correspond to divisions of the range; and
arrange the three-dimensional graphics objects as the collage; and
wherein arranging the content objects as the three-dimensional collage comprises positioning the content objects on the three-dimensional graphics objects.

23. The apparatus of claim 22, wherein the range comprises a time range and the divisions of the range comprise time slices.

24. The apparatus of claim 22, wherein the three-dimensional graphics objects are arranged according to a straight-on layout arrangement, a staggered layout arrangement, and a side-by-side layout arrangement.

25. The apparatus of claim 22, wherein:
the processor executes instructions to receive a layout arrangement control parameter; and
the three-dimensional graphics objects are arranged in accordance with the layout arrangement control parameter.

26. The apparatus of claim 22, wherein at least one of the three-dimensional graphics objects includes an audio component.

27. The apparatus of claim 21, wherein the processor executes instructions to:
create a three-dimensional graphics environment for the three-dimensional collage.

28. The apparatus of claim 21, wherein the three-dimensional collage comprises an electronic program guide that identifies shows that are broadcast at specified times.

29. An apparatus comprising:
a memory that stores executable instructions; and
a processor that executes the instructions to:
receive control parameters;
create content objects in accordance with at least one of the control parameters;
create three-dimensional graphics objects in accordance with at least one of the control parameters;
arrange the three-dimensional graphics objects in accordance with at least one of the control parameters; and
position the content objects on the three-dimensional graphics objects.

30. The apparatus of claim 19, wherein the control parameters comprise parameters that identify electronic content for the content objects, identify a range and divisions to the range for the three-dimensional graphics objects, and a layout arrangement for the three-dimensional graphics objects.
